(19) United States
(12) Patent Application Publication
(10) Pub. No.: US 2011/0010074 A1
(43) Pub. Date: Jan. 13, 2011

(54) Methods Of Controlling An Internal Combustion Engine Including Multiple Fuels And Multiple Injectors

(75) Inventors: David Ling-Shun Hung, Novi, MI (US); Guoming George Zhu, Novi, MI (US)

Correspondence Address: DICKINSON WRIGHT PLLC, 1875 Eye Street, NW, Suite 1200, WASHINGTON, DC, 20006, US

(73) Assignee: VISTEON GLOBAL TECHNOLOGIES, INC., Van Buren Township, MI (US)

(21) Appl. No.: 12/500,460

(22) Filed: Jul. 9, 2009

(51) Int. Cl. F02D 43/00; F02B 17/00; F02M 25/07

(52) U.S. Cl. 701/103; 123/295; 123/568.11

(57) ABSTRACT

A method for controlling the start of combustion and peak burn rate of an internal combustion engine system on a cycle-to-cycle basis including multiple direct fuel injectors, multiple indirect fuel injectors, and multiple liquid fuels. The actual start of combustion and actual peak burn rate are calculated using in-cylinder pressure or ionization. A predetermined start of combustion and a predetermined peak burn rate are selected. The start of combustion and peak burn rate control algorithm includes controlling a fuel ratio, an injection ratio, and a residual gas recirculation ratio. A predetermined fuel ratio, a predetermined injection ratio, and a predetermined residual gas recirculation are calculated by combining feed forward ratios and closed loop control ratios corresponding to the three ratios. The predetermined ratios are employed so that the system achieves the predetermined start of combustion and predetermined peak burn rate.

### BACKGROUND OF THE INVENTION

1. Field of the Invention

The present invention relates to a method for controlling the start of combustion and peak burn rate for an internal combustion engine system.

2. Description of the Prior Art

Existing internal combustion engine systems typically operate in homogeneous charge spark ignition or stratified charge compression ignition. Homogeneous charge spark ignition engines are commonly referred to as gasoline engines where the fuel and oxidizers typically air, are mixed together, compressed, and ignited with an electrical discharge, typically a spark plug. Stratified charge compression engines are commonly referred to as diesel engines, and typically operate by using temperature and density increases resulting from compression, with combustion occurring at a boundary of fuel-air mixing, caused by an injection event, typically the injection of fuel, to initiate combustion.

Recently, manufacturers have been turning to homogeneous charge compression ignition (HCCI), which has been known for some time as a potential engine system to improve fuel economy. HCCI engines can also achieve very low levels of Nitrogen oxide emissions (NTO) without an after-treatment catalytic converter. In such engine systems, a homogeneous mixture of fuel and air is compressed, and combustion begins when the appropriate engine conditions are reached, typically at a high pressure in the combustion chamber. HCCI engine systems are unique in that the ignition occurs at several places in the combustion chamber at a time, so the mixture of fuel and air burns nearly simultaneously. However, there is no direct or well-defined initiator of combustion in HCCI engine systems, so the system is inherently challenging to control accurately and consistently on a cycle-to-cycle basis. Without accurate and consistent control, inefficient fuel economy and increased knock may occur. An HCCI system is especially difficult to control in engines using multiple fuels and including multiple fuel injectors, due to the increased number of variables.

Currently, there are several methods used in attempt to control HCCI engine systems. One method used to control the start of combustion involves controlling a variable compression ratio with a movable plunger at the top of the cylinder head. However, this approach requires a significant amount of energy to achieve fast responses, is expensive to implement and manufacture, and the reliability of such a system over the life cycle of a vehicle and in different environments is unknown.

A second method used in attempt to control the start of combustion includes controlling an induction temperature of the engine system. For example, the engine can include an intake heater to control the intake air temperature and in-cylinder fuel-to-air mixture temperature. However, this method is slow and cannot be adjusted on a cycle-to-cycle basis, which may result in inaccurate control. Another example is fast thermal management (FTM), which involves rapidly changing the cycle-to-cycle intake fuel-air mixture temperature by rapidly mixing hot and cold air streams. However, FTM has limitations associated with actuator energy and is expensive to implement.

A third method includes using a valve to adjust the amount of residual exhaust gas, or residual exhaust gas recirculation for each engine cycle. A fast valve actuator, such as an Electro-Magnetic-Valve-Actuator (EMVA), Electro-Hydraulic-Valve-Actuator (EHVA), or Electro-Pneumatic-Valve-Actuator (EPVA) can be used to adjust the in-cylinder gas mixture so that it includes a predetermined amount of residual exhaust gas for each individual cycle. However, this method does not allow the residual exhaust gas recirculation rate to remain at a predetermined desired level on a cycle-to-cycle basis, which may lead to inconsistencies in the start of combustion. The inability to accurately and consistently control the start of combustion in an HCCI engine system hinders the widespread commercialization of HCCI engine systems in internal combustion engines.

### SUMMARY OF THE INVENTION

The present invention is directed towards a method for controlling both the start of combustion and peak burn rate of an internal combustion engine system. The method can be used to control an engine using multiple fuels and including multiple injectors. The method includes controlling a fuel ratio, an injection ratio, and a residual gas recirculation ratio. The ratios are used to control a start of combustion and a peak burn rate. The method provides for accurate and consistent control of the start of combustion and peak burn rate of an HCCI engine system on a cycle-to-cycle basis. The controlled start of combustion and peak burn rate can lead to improved fuel economy and reduced knock.

The start of combustion and peak burn rate can be advanced or retarded by adjusting or tuning the three control ratios of the system, namely the fuel ratio, injection ratio, and residual as recirculation ratio. In other words, the control algorithms for both the start of combustion and peak burn rate include the fuel ratio, injection ratio, and residual gas recirculation ratio. A control module including a feed forward controller and a multi-input and multi-output controller can be used to tune the three control ratios and monitor the conditions and parameters of the engine. Also, the same operating parameters, specifically in-cylinder pressure or ionization signal, can be used to detect both the start of combustion and peak burn rate. Thus, the start of combustion and peak burn rate can be controlled consistently and accurately on a cycle-to-cycle basis so that the engine achieves optimal performance. Another advantage of the method is that it provides for a cost-effective and energy efficient engine system. A single control module can measure the relevant operating parameters of the system. No additional engine parts or significant amounts of energy, which could reduce the engine power and fuel economy, are required. Also, the control algorithm provides quick detection of the system parameters and quick adjustments of the ratios on a cycle-to-cycle basis.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a partial schematic diagram of an exemplary internal combustion engine system;

FIG. 2 is a flow chart of an exemplary process of the present invention wherein a predetermined start of combustion and predetermined peak burn rate are selected;

FIG. 3 is a flow chart of an exemplary process of the present invention wherein a predetermined fuel-to-air mixture temperature is selected;

FIG. 4 is a graph showing derivative information used to detect the actual peak burn rate; and

FIG. 5 is an exemplary control block diagram of the present invention.

### DETAILED DESCRIPTION OF THE INVENTION

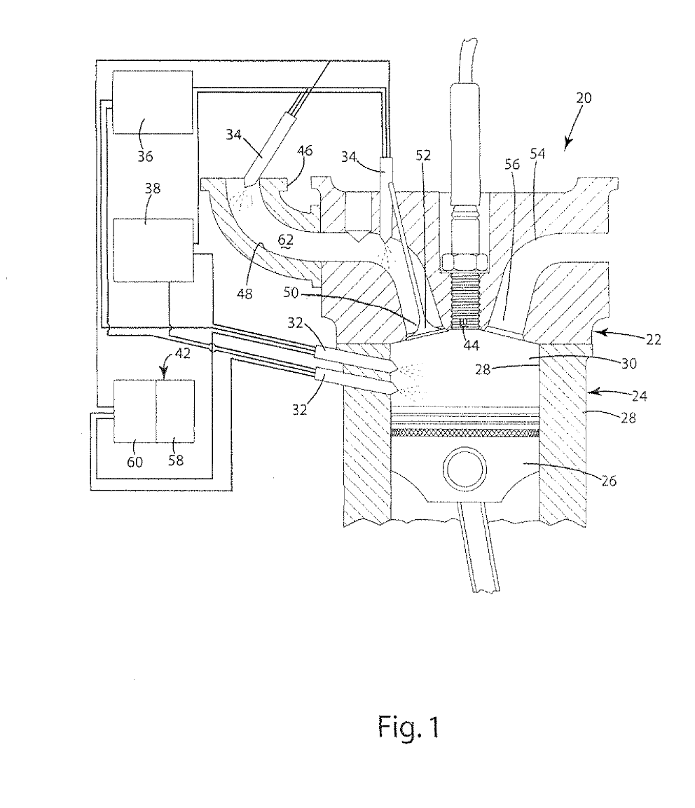

Referring to the Figures, wherein like numerals indicate corresponding parts throughout the several views, an exemplar internal combustion engine 20 incorporating the present invention is generally shown in FIG. 1. The engine 20 shown in FIG. 1 and described below is given by way of illustration only and does not limit the scope of the present invention.

The present invention is well suited to work with internal combustion engines 20 that can operate by a spark ignition engine system, a homogeneous charge compression ignition (HCCI) or spark-assisted HCCI engine system. The engine 20 generally includes an engine block 22 including a cylinder 24 formed in the engine block 22 and a piston 26 which moves up and down in the cylinder 24. The piston 26 and inside wall 28 of the cylinder 24 define a combustion chamber 30, as shown in FIG. 1. The engine 20 includes fuel injectors 32, 34 for delivering fuels 36, 38 to the engine 20 and an exhaust path 40 for allowing exhaust gas to exit the engine 20. The engine 20 also includes or is operatively connected to a control module 42. The control module 42 implements the method of controlling the start of combustion (SOC) and peak burn rate (PBR) of a fuel-air mixture in the combustion chamber 30 of the engine 20.

The engine block 22 serves as a rigid metal foundation for the engine 20. The engine block 22 can be created in a variety of different designs, configurations, and installed in a variety of different vehicles. The engine block 22 includes at least one cylinder 24 formed therein. The engine block 22 can include multiple cylinders 24, (not illustrated) depending on the application. The cylinder 24 includes the inside wall 28 defining a hollow chamber. The cylinder 24 can be cast into the engine block 22 and then bored and honed to a smooth finish, installed in the form of a separate cylinder sleeve (not illustrated) pressed into the engine block 22, or formed by another desired method. If a cylinder sleeve is used then it can be secured in a variety of ways, such as friction alone or by a flange on the top edge of the cylinder sleeve that fits into a grove in the engine block 22. A cylinder head is generally coupled to the engine block 22, such as being bolted onto the engine block 22 above the cylinder 24. For spark-assisted systems, the engine 20 can include an ignition device, such as a spark plug and coil 44 extending through the inside wall 28 of the cylinder 24 and into the combustion chamber 30, as shown in FIG. 1.

The piston 26 is disposed in the cylinder 24 and can slide or rock up and down in the cylinder 24. During operation, the piston 26 cycles, such as travels away from the cylinder head to produce a vacuum to draw in fuel and an oxidizer, such as air, and then toward the cylinder head to compress a fuel-air mixture. The piston 26 may be formed from a variety of materials, such as a cast aluminum material having good wear characteristics. The piston 26 and inside wall 28 of the cylinder 24 and cylinder head define a combustion chamber 30 therebetween, as shown in FIG. 1. For engines 20 including multiple cylinders 24, a piston 26 is disposed in each cylinder 24.

A throttle body 46 controls the amount of air flowing into the engine 20. An intake manifold 48 forming a closed passageway 62 connects the throttle body 46 and the cylinder 24. The intake manifold 48 includes an intake port 50 at the entrance of the combustion chamber 30. An intake valve 52 is disposed in the intake port 50 to control the amount of fuel-air mixture entering the combustion chamber 30. Although not illustrated, the engine 20 can include multiple manifolds 48 and intake ports 50, depending on the application.

The engine 20 includes a fuel system typically including multiple direct fuel injectors 32 adapted to inject the fuels 36, 38 directly into the combustion chamber 30 of the cylinder 24, and multiple indirect fuel injectors 34 adapted to inject the fuels 36, 38 into the engine 20 prior to entering the combustion chamber 30. The engine 20 can include two direct fuel injectors 32 disposed at different locations and allowing the fuels 36, 38 to enter the combustion chamber 30 at different points and at different injection timings relative to the engine cycle, which supplements or improves mixing of the fuels 36, 38 and fuel-air mixture in the combustion chamber 30. The indirect fuel injectors 34 can include a throttle body injector for injecting the fuels 36, 38 into the throttle body 46 adjacent the entrance to the intake manifold 48. The indirect fuel injectors 34 can also include a manifold injector for injecting the fuels 36, 38 into the intake manifold 48, or a port fuel injector for injecting the fuels 36, 38 into the intake port 50 just ahead of the intake valve 52. The injectors 32, 34 may spray the fuel in any desired shape, such as spraying the fuel in a cone-shaped pattern for efficient distribution and atomization. Each of the injectors 32, 34 can include the same or different amounts of the fuels 36, 38 and types of the fuels 36, 38.

The engine 20 typically uses two fuels 36, 38, or fuel mixtures, which are injected into the engine 20 through the fuel injectors 32, 34. The first fuel 36 is typically a fossil fuel and the second fuel 38 is typically an alternative fuel. However, the fuels 36, 38 can be reversed so that the first fuel 36 is an alternative fuel and the second fuel 38 is a fossil fuel. Alternatively, the engine 20 can use other types of fuels or only one type of fuel. Examples of the first fuel 36, or fossil fuel, include gasoline, a gasoline blend, diesel, or a diesel blend. Examples of the second fuel 38, or alternative fuel, include an alcohol-based fuel in a liquid state such as ethanol, methanol, butanol, or any blend thereof. The alternative fuel can also include liquefied petroleum, liquefied hydrogen, liquefied natural gas, or liquefied biodiesel. Alternatively, each of the fuels 36, 38 can include a mixture of different fuels. The two fuels 36, 38 or fuel mixtures enter the combustion chamber 30 directly through multiple direct fuel injectors 32. The multiple direct fuel injectors 32 supplement the mixing of the fuels 36, 38 and fuel-air mixture in the combustion chamber 30 because the fuels 36, 38 enter the combustion chamber 30 at different points, rather than at a single point. The multiple direct fuel injectors 32 can also inject the fuels 36, 38 at different injection timings rather than at a single timing. In other words, engines 20 including the multiple fuel injectors 32, 34 achieve better mixing of the fuels 36, 38 and fuel-air mixture than engines including a single injector, which only inject the fuels 36, 38 into the combustion chamber 30 at a single point. The two fuels 36, 38 can also enter the intake manifold 48 or intake port 50 of the engine 20 through the multiple indirect fuel injections 34, mix with the air flow controlled by the throttle body 46, and then the fuel-air mixture can enter the combustion chamber 30 where combustion occurs. The multiple indirect fuel injectors 34 also supplement the mixing of the fuels 36, 28 and the fuel-air mixture in the engine 20.

As stated above, the engine 20 can employ an HCCI engine system operating in cycles to generate energy. Each engine cycle includes the piston 26 beginning at the top of the cylinder 24. The intake valve 52 opens and the piston 26 moves down the cylinder 24 to draw the fuel-air mixture into the combustion chamber 30. Next, the piston 26 moves back up the cylinder 24 compressing the fuel-air mixture to the point of ignition, which is referred to as the start of combustion (SOC). Alternatively, the ignition coil 44 can emit a spark to assist in igniting the compressed fuel-air mixture to start combustion. The explosion of the fuel-air mixture occurring at the start of combustion (SOC) drives the piston 26 back down the cylinder 24 and away from the cylinder head. The piston 26 then cycles up the cylinder 24 to exhaust the gases after combustion. Some of the exhaust gas travels to the tail pipe, and a residual amount of the exhaust gas is recirculated to the intake manifold 48 and then back to the combustion chamber 30. This engine cycle occurs repeatedly during operation of the engine 20. The rate at which the fuel-air mixture burns in the combustion chamber 30 is referred to as the burn rate. The burn rate is a measure of the linear combustion rate of the fuel-air mixture in the combustion chamber 30. The burn duration, which is the amount of time the fuel-air mixture burns, depends on the peak burn rate (PBR) of the fuel-air mixture.

As alluded to above, the engine 20 includes the exhaust path 40 allowing exhaust gas to exit the combustion chamber 30. When the piston 26 moves up the cylinder 24, it creates enough pressure to force exhaust gas out of the combustion chamber 30 and into an exhaust port 56 of an exhaust manifold 54 connected to the cylinder 24. The exhaust manifold 54 can connect to the exhaust pipes. The engine 20 also includes a residual gas recirculation valve (not illustrated) or another element allowing a controlled amount of the residual exhaust gas to enter the intake manifold 48 and travel to the combustion chamber 30. The recirculated residual exhaust gas lowers exhaust emissions and improves the fuel economy of the engine system.

The engine 20 includes the control nodule 42, which is operatively connected to the injectors 32, 34, as shown in FIG. 1. Specifically, the engine 20 includes a feed forward controller 58 and a multi-input and multi-output controller 60, as shown in FIG. 1, which may be integrated into a single controller or control module 42. The control module 42 can be coupled to sensors and detectors to monitor engine operating parameters. The control module 42 controls the amount and injection timing of each of the fuels 36, 38 conveyed to each of the injectors 32, 34 and injected into the engine 20 and the amount of residual gas recirculated to the intake manifold 48. The control module 42 is also adapted to implement the method of the present invention.

As alluded to above, the subject invention includes the method of controlling the engine system, specifically the start of combustion (SOC) and the peak burn rate (PBR) during operation of the engine 20 on a cycle-to-cycle basis. The subject invention can also control the in-cylinder fuel-air mixture temperate (T), which directly affects the start of combustion (SOC) and peak burn rate (PBR). The method can be used for controlling engines 20 of the type described above, having multiple fuel injectors 32, 34 and multiple liquid fuels 36, 38. As alluded to above, the method can be used to control engines operating with the HCCI combustion.

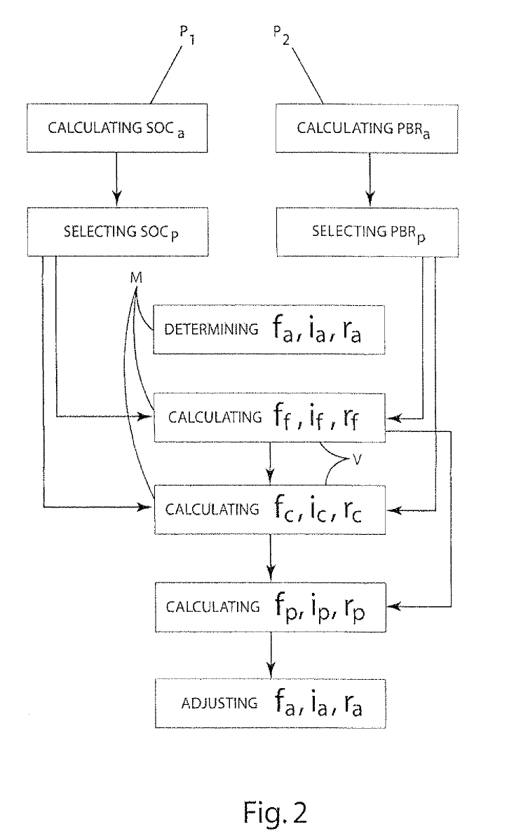

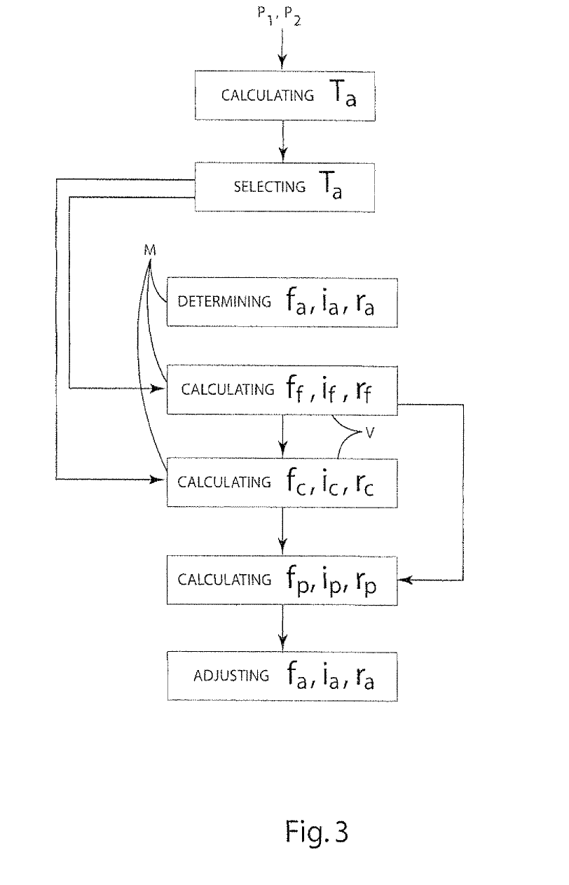

The method includes the step of calculating the actual start of combustion (SOCₐ) of the engine 20 system, which is when the compressed air-fuel mixture ignites in the combustion chamber 30. The actual start of combustion (SOCₐ) is calculated using a first operating parameter of the system (p₁), as illustrated in FIG. 2. The first operating parameter (p₁) is typically in-cylinder pressure or ionization. As alluded to above, the first operating parameter (p₁) can be measured by sensors or detectors. Alternatively, the method can include calculating the actual fuel-air mixture temperature (Tₐ), as illustrated in FIG. 3, which is directly related to the start of combustion (SOC) and peak burn rate (PBR). For example, increasing the fuel-air mixture temperature (T) advances the start of combustion (SOC) and peak burn rate (PBR), and decreasing the fuel-air mixture temperature (T) retards the start of combustion (SOC) and peak burn rate (PBR).

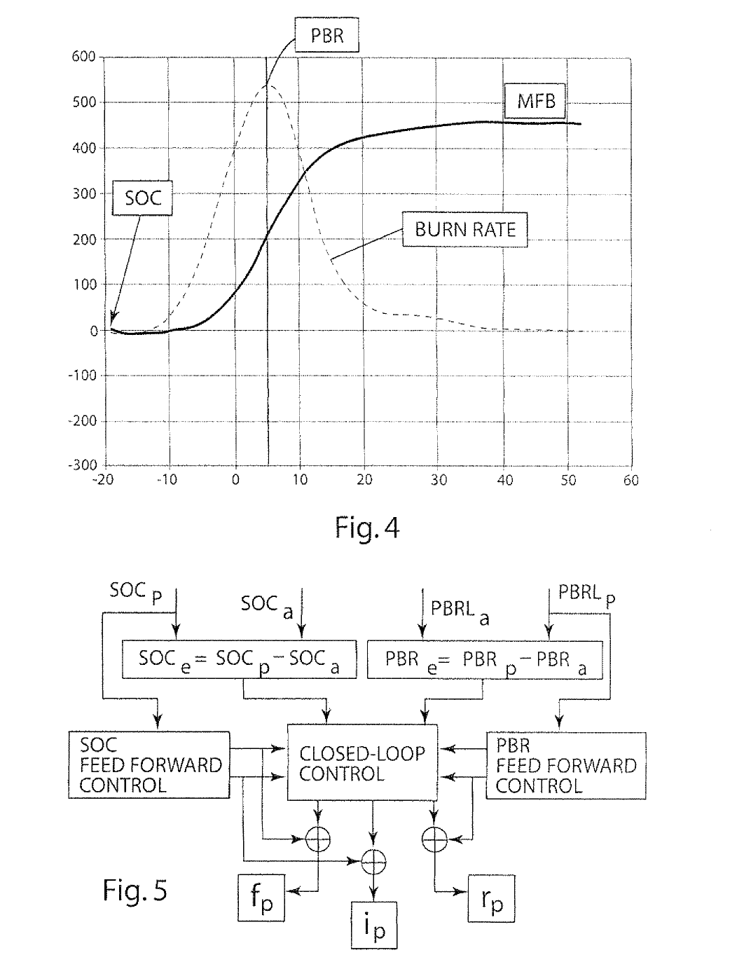

The method also includes calculating the actual peak burn rate (PBRₐ) of the system. As stated above, the peak burn rate (PBR) directly impacts the burn duration of the fuel-air mixture in the combustion chamber 30, which impacts performance of the engine 20. The actual peak burn rate (PBRₐ) is calculated using a second operating parameter (p₂), as illustrated in FIG. 2, which can also be in-cylinder pressure or ionization. In other words, the same operating parameter can be used to detect both the actual start of combustion (SOCₐ) and the actual peak burn rate (PBRₐ). Specifically, the in-cylinder pressure can be used to calculate a mass-fraction-burned (MFB) of the fuel, which can then be used to calculate the actual start of combustion (SOCₐ). The actual peak burn rate (PBRₐ) is located at the peak of the burn rate, as shown in FIG. 4. Alternatively, the ionization signal can be used to detect the actual start of combustion (SOCₐ), which occurs when an ionization current starts to flow through a detection circuit of the system. The actual peak burn rate (PBRₐ) occurs when the ionization current is at a peak.

Next, the method includes selecting a predetermined start of combustion (SOCₚ) and a predetermined peak burn rate (PBRₚ), as illustrated in FIG. 2, which are desired or ideal values. The predetermined start of combustion (SOCₚ) selected can be advanced or retarded of the actual start of combustion (SOCₐ), and the predetermined peak burn rate (PBRₚ) can also be advanced or retarded of the actual peak burn rate (PBRₐ). Alternatively, a predetermined fuel-air mixture temperature (Tₚ) can be selected, as illustrated in FIG. 3.

Once the predetermined start of combustion (SOCₚ) and predetermined peak burn rate (PBRₚ), or the predetermined fuel-air mixture temperature (Tₚ), are determined, the method includes controlling a fuel ratio (f), an injection ratio (i), and a residual gas recirculation ratio (r) of the system so that the system achieves the predetermined start of combustion (SOCₚ) and the predetermined peak burn rate (PBRₚ), or the predetermined fuel-air mixture temperature (Tₚ). In other words, the start of combustion (SOC) control algorithm and peak burn rate (PBR) control algorithm, or fuel-air mixture temperature (Tₐ) control algorithm, employs three ratios: the fuel ratio (f), the injection ratio (i), and the residual gas recirculation ratio (r).

The fuel ratio (f) is defined as a mass of the first fuel 36 entering the system relative to a mass of the second fuel 38 entering the system. As alluded to above, the first fuel 36 can be a fossil fuel, such as gasoline, and the second fuel 38 can be an alternative fuel, such as ethanol. Each of the multiple direct fuel injectors 32 and multiple indirect fuel injectors 34 can inject the two fuels 36, 38 into the system. Each of the fuel injectors 32, 34 can have a corresponding fuel ratio (f), identical to or different from the fuel ratios (f) of the other fuel injectors 32, 34 of the system. Thus, the fuel ratio (f) can include or account for multiple fuel ratios (f).

The injection ratio (i) is defined as a mass of the fuels 36, 38 entering the system through the multiple indirect fuel injectors 34 relative to a mass of the fuels 36, 38 entering the system through the multiple direct fuel injectors 32. As stated above, the system typically includes multiple direct injectors 32 and multiple indirect fuel injectors 34, each capable of injecting the fuels 36, 38 into the system and having a corresponding fuel ratio (f). As stated above, the fuel ratio (f) of each injector 32, 34 can be identical to or different from fuel ratio (f) of the other fuel injectors 32, 34. Thus the injection ratio (i) can include or account for multiple ratios. The throttle body injectors, manifold injectors, and port fuel injectors are considered indirect fuel injectors 34 for purposes of the injection ratio (i). The residual gas recirculation ratio (r) is defined as a mass of the residual exhaust gas trapped in the combustion chamber 30 of the cylinder 24 from a preceding engine cycle divided by a mass of the residual exhaust gas trapped in the combustion chamber 30 prior to the start of combustion (SOC). The multiple fuel injectors 32, 34, especially the direct fuel injectors 32, improve the mixing of the fuels 36, 38 and fuel-air mixture in the engine system.

Controlling the ratios (f, i, r) first involves determining an actual fuel ratio (fₐ), an actual injection ratio (iₐ), and an actual residual gas recirculation ratio (rₐ) of the system, as illustrated in FIG. 2. Determining the actual fuel ratio (fₐ) and actual injection ratio (iₐ), which is used for controlling the ratios (f, i, r) of the system, includes accounting for the multiple fuels 36, 38, multiple direct fuel injectors 32, and multiple indirect fuel injectors 34. The control module 42 can determine the actual ratios (fₐ, iₐ, rₐ) using engine mapping information (m).

Next, the method includes calculating a feed forward fuel ratio (f), a feed forward injection ratio (i_{f}), and a feed forward residual gas recirculation ratio (r_{f}), corresponding to the actual ratios (fₐ, iₐ, rₐ) of the system, as illustrated in FIG. 2. The feed forward controller 58 can calculate the feed forward fuel ratio (f_{f}) and feed forward injection ratio (fᵢ) using the engine mapping information (m) and predetermined start of combustion (SOCₚ). Determining the feed forward fuel ratio (f_{f}) and feed forward injection ratio (i_{f}), which is used for controlling the ratios (f, i, r) of the system, includes accounting for the multiple fuels 36, 38, multiple direct fuel injectors 32, and multiple indirect fuel injectors 34. The feed forward controller 58 can also calculate the feed forward residual gas recirculation ratio (r_{f}) using the engine mapping information (m) and the predetermined peak burn rate (PBRₚ).

The method also includes calculating a closed loop control fuel ratio (f_{c}), a closed loop control injection ratio (i_{c}), and a closed loop control residual gas recirculation ratio (r_{c}), corresponding to the actual ratios (fₐ, iₐ, rₐ) of the system, as illustrated in FIG. 2. The multi-input and multi-output controller 60 can calculate the closed loop control ratios (f_{c}, i_{c}, r_{c}). The multi-input and multi-output controller 60 can be a MIMO Proportional-Integrative (PI) controller or any other control module employing a MIMO closed loop control strategy. The engine mapping information (m), the feed forward fuel ratio (f_{f}), and a start of combustion error (SOC_{c}) can be used to calculate the closed loop control fuel ratio (f_{c}). The engine mapping information (m), the feed forward injection ratio (i_{f}), and the start of combustion error (SOC_{c}), can be used to calculate the closed loop control injection ratio (i_{c}). The start of combustion error (SOCₑ) is defined as the difference between the predetermined start of combustion (SOCₚ) and the actual start of combustion (SOCₐ), as illustrated in FIG. 5. Determining the closed loop control fuel ratio (f_{c}) and closed loop control injection ratio (i_{c}), which is used for controlling the ratios (f, i, r) of the system, includes accounting for the multiple fuels 36, 38, multiple direct fuel injectors 32, and multiple indirect fuel injectors 34. The engine mapping information (m), the feed forward residual gas recirculation ratio (r_{f}), and a peak burn rate error (PBRₑ) can be used to calculate the closed loop control residual gas recirculation ratio (r_{c}). The peak burn rate error (PBRₑ) is defined as the difference between the predetermined peak burn rate (PBRₚ) and the actual peak burn rate (PBRₐ), as illustrated in FIG. 5.

The feed forward fuel ratio (f_{f}), feed forward injection ratio (i_{f}), closed loop control fuel ratio (f_{c}), and closed loop control injection ratio (i_{c}) can be calculated in cooperation with one another. If the predetermined start of combustion (SOCₚ) is advanced of the actual start of combustion (SOCₐ), one way to calculate these feed forward ratios (f_{f}, i_{f}, r_{f}) and closed loop control ratios (f_{c}, i_{c}, r_{c}) includes increasing the actual injection ratio (iₐ) while keeping the actual fuel ratio (fₐ) constant until the actual injection ratio (iₐ) reaches a first predetermined value (v₁) followed by increasing the actual fuel ratio (fₐ) to reach a second predetermined value (v₂). The first predetermined value (v₁) corresponding to the actual injection ratio (iₐ) is typically about 80% of a threshold of the system. The second predetermined value (v₂) corresponding to the actual fuel ratio (fₐ) is also typically about 80% of a threshold of the system. A second way to calculate these feed forward ratios (f_{f}, i_{f}, r_{f}) and closed loop control ratios (f_{c}, i_{c}, r_{c}) when the predetermined start of combustion (SOCₚ) is advanced of the actual start of combustion (SOCₐ) includes increasing the actual fuel ratio (fₐ) while keeping the actual injection ratio (iₐ) constant until the actual fuel ratio (fₐ) reaches the second predetermined value (v₂) followed by increasing the actual injection ratio (iₐ) to reach the first predetermined value (v₁). A third way to calculate these ratios (f_{f}, i_{f}, r_{f}, f_{c}, i_{c}, r_{c}) when the predetermined start of combustion (SOCₚ) is advanced of the actual start of combustion (SOCₐ) includes simultaneously increasing the actual fuel ratio (fₐ) and the actual injection ratio (iₐ) so the actual ratios (fₐ, iₐ, rₐ) reach the corresponding predetermined values (v₁, v₂).

If the predetermined start of combustion (SOCₚ) is retarded of the actual start of combustion (SOCₐ), one way to calculate these feed forward ratios (f_{f}, i_{f}, r_{f}) and closed loop control ratios (f_{c}, i_{c}, r_{c}) includes decreasing the actual injection ratio (iₐ) to reach the first predetermined value (v₁) while keeping the actual fuel ratio (fₐ) constant followed by decreasing the actual fuel ratio (fₐ) to equal the second predetermined value (v₂). A second way includes decreasing the actual fuel ratio (fₐ) to reach the second predetermined value (v₂) while keeping the actual injection ratio (iₐ) constant followed by decreasing the actual injection ratio (iₐ) to reach the first predetermined value (v₁). A third way includes simultaneously decreasing the actual fuel ratio (fₐ) and actual injection ratio (iₐ) so that each of these actual ratios (fₐ, iₐ, rₐ) reach the corresponding predetermined values (v₁, v₂).

There are also several ways to calculate the feed forward residual gas recirculation ratio (r_{f}) and the closed loop control residual gas recirculation ratio (r_{c}). If the predetermined peak burn rate (PBRₚ) is advanced of the actual peak burn rate (PBRₐ), one way to calculate these residual gas recirculation ratios (r_{f}, r_{c}) includes fixing the actual start of combustion (SOCₐ), or selecting a predetermined start of combustion (SOCₚ) equal to the actual start of combustion (SOCₐ), and then reducing the actual residual gas recirculation ratio (rₐ) to equal a third predetermined value (v₃). If the predetermined peak burn rate (PBRₚ) is retarded of the actual peak burn rate (PBRₐ), a second way to calculate these residual gas recirculation ratios (r_{f}, r_{c}) includes fixing the actual start of combustion (SOCₐ) and then increasing the actual residual gas recirculation ratio (rₐ) to equal the third predetermined value (v₃).

After the feed forward ratios (f_{f}, i_{f}, r_{f}) and closed loop control ratios (f_{c}, i_{c}, r_{c}) are calculated, the method includes calculating a predetermined fuel ratio (fₚ), a predetermined injection ratio (iₚ), and a predetermined residual gas recirculation ratio (rₚ). The predetermined ratios (fₚ, iₚ, rₚ) are calculated by combining or adding the feed forward ratios (f_{f}, i_{f}, r_{f}) and the closed loop control ratios (f_{c}, i_{c}, r_{c}), as illustrated in FIG. 2 and FIG. 5. Specifically, the method includes combining the feed forward fuel ratio (f_{f}) and closed loop control fuel ratio (f_{c}); combining the feed forward injection ratio (i_{f}) and the closed loop control injection ratio (i_{c}); and combining the feed forward residual gas recirculation ratio (r_{f}) and the closed loop control residual gas recirculation ratio (r_{c}).

Finally, the method includes adjusting the actual ratios (fₐ, iₐ, rₐ) of the system to equal the predetermined ratios (fₚ, iₚ, rₚ), as illustrated in FIG. 2, whereby the system achieves the predetermined start of combustion (SOCₚ) and predetermined peak burn rate (PBRₚ). Specifically, the method can include adjusting the actual fuel ratio (fₐ) of the system to equal the predetermined fuel ratio (fₚ); adjusting the actual injection ratio (iₐ) of the system to equal the predetermined injection ratio (iₚ); and adjusting the actual residual gas recirculation ratio (rₐ) of the system to equal the predetermined residual gas recirculation ratio (rₚ). The control module 42 can be used to adjust the actual ratios (fₐ, iₐ, rₐ) of the system.

As alluded to above, the actual fuel-air mixture temperature (Tₐ), predetermined fuel-air mixture temperature (Tₚ), and an fuel-air mixture temperature error (Tₑ) can be used instead of the start of combustion (SOC) and peak burn rate (PBR) values to calculate the ratios (f, i, r), as shown in FIG. 3. The ratios (f, i, r) can be controlled or adjusted to achieve the predetermined fuel-air mixture temperature (Tₚ), which directly impacts the start of combustion (SOC) and peak burn rate (PBR).

What is claimed is:

1. A method for controlling an internal combustion engine system comprising the steps of;
controlling a fuel ratio of the system;
controlling an injection ratio of the system;
controlling a residual gas recirculation ratio of the system; and
using said ratios to control a start of combustion and a peak burn rate.

2. A method as set forth in claim 1 wherein said controlling the fuel ratio and said controlling the injection ratio includes accounting for multiple direct fuel injectors.

3. A method as set forth in claim 1 wherein said controlling the fuel ratio and said controlling the injection ratio includes accounting for multiple indirect fuel injectors.

4. A method as set forth in claim 1 wherein said controlling the fuel ratio and said controlling the injection ratio includes using a predetermined start of combustion.

5. A method as set forth in claim 1 wherein said controlling the residual gas recirculation ratio includes using a predetermined peak burn rate.

6. A method as set forth in claim 1 wherein said controlling the ratios includes obtaining a predetermined ratio corresponding to at least one of the fuel ratio and the injection ratio and the residual gas recirculation ratio using engine mapping information.

7. A method as set forth in claim 6 wherein said obtaining the predetermined ratio includes obtaining a feed forward ratio corresponding to the predetermined ratio.

8. A method as set forth in claim 6 wherein said obtaining the predetermined ratio includes obtaining a closed loop control ratio corresponding to the predetermined ratio.

9. A method as set forth in claim 6 wherein said obtaining the predetermined ratio includes combining a feed forward ratio and a closed loop control ratio corresponding to the predetermined ratio.

10. A method as set forth in claim 6 wherein said combining the feed forward ratio and a closed loop control ratio is further defined as adding the feed forward ratio and closed loop control ratio corresponding to the predetermined ratio.

11. A method as set forth in claim 6 including adjusting the at least one ratio of the system to equal the corresponding predetermined ratio.

12. A method as set forth in claim 1 including controlling the ratios on a cycle-to-cycle basis.

13. A method as set forth in claim 1 including accounting for a first fuel including a fossil fuel and a second fuel including an alternative fuel in the fuel ratio.

14. A method as set forth in claim 1 including accounting for a homogeneous charge compression ignition (HCCI) combustion.

15. A method as set forth in claim 1 including calculating an actual start of combustion using a first operating parameter of the system and wherein said controlling the ratios includes using the actual start of combustion.

16. A method as set forth in claim 15 wherein said first operating parameter is in-cylinder pressure.

17. A method as set forth in claim 15 wherein said first operating parameter is an ionization signal in the cylinder.

18. A method as set forth in claim 15 including calculating an actual peak burn rate using a second operating parameter of the system wherein said controlling the ratios includes using the actual peak burn rate.

19. A method as set forth in claim 18 wherein said second operating parameter is equal to said first operating parameter.

20. A method for controlling an internal combustion engine system comprising the steps of;
obtaining a predetermined fuel ratio by combining a feed forward fuel ratio and a closed loop control fuel ratio;
obtaining a predetermined injection ratio by combining a feed forward injection ratio and a closed loop control injection ratio;
obtaining a predetermined residual gas recirculation ratio by combining a feed forward residual gas recirculation ratio and a closed loop control residual gas recirculation ratio; and
using the predetermined ratios to control a start of combustion and a peak burn rate.

21. A method as set forth in claim 20 wherein said combining the ratios includes adding the feed forward ratio and the corresponding closed loop control ratio.

22. A method as set forth in claim 20 wherein said obtaining the fuel ratio and said obtaining the injection ratio includes using a predetermined start of combustion.

23. A method as set forth in claim 20 wherein said obtaining the residual gas recirculation ratio includes using a predetermined peak burn rate.

24. A method as set forth in claim 20 including accounting for a homogeneous charge compression ignition (HCCI) combustion.

25. A method for controlling an internal combustion engine system comprising the steps of;
controlling a fuel ratio of the system;
controlling an injection ratio of the system;
controlling a residual gas recirculation ratio of the system; and
using said ratios to control a fuel-air mixture temperature.

26. A method as set forth in claim 25 wherein;
said controlling the fuel ratio and said controlling the injection ratio includes using a predetermined start of combustion, and
said controlling the residual gas recirculation ratio includes using a predetermined peak burn rate.

27. A method as set forth in claim 25 including;
accounting for a first fuel including gasoline and a second fuel including ethanol in the fuel ratio;
accounting for a plurality of indirect fuel injectors and a plurality of direct fuel injectors in the injection ratio; and
accounting for a homogeneous charge compression ignition (HCCI) combustion.
